(19) United States
(12) Patent Application Publication
(10) Pub. No.: US 2007/0245729 A1
(43) Pub. Date: Oct. 25, 2007

(54) DIRECTIONAL GEOTHERMAL ENERGY SYSTEM AND METHOD

(76) Inventor: D. Lynn Mickleson, Palmer, AK (US)

Correspondence Address: DAVIS WRIGHT TREMAINE, LLP, 1201 Third Avenue, Suite 2200, SEATTLE, WA, 98101-3045, US

(21) Appl. No.: 11/468,698

(22) Filed: Aug. 30, 2006

Related U.S. Application Data
(60) Provisional application No. 60/745,376, filed on Apr. 21, 2006.

(51) Int. Cl. F03G 7/00

(52) U.S. Cl. 60/641.3; 60/641.2

(57) ABSTRACT

A directional geothermal energy system and method helps to increase control in paths to be taken by geo-fluid flow through hot rock to create engineered geothermal reservoirs and networks to mine heat from hot rock resources. The system uses directional drilling techniques to create a spanning borehole extending between an injection borehole and a production borehole. The spanning borehole typically extends through hot rock for a distance on the order of kilometers to allow the geo-fluid flowing through the spanning borehole adequate transit time and surface contact to obtain sufficient heat given a certain flow rate for the geo-fluid. In some implementations, multiple injection boreholes can supply geo-fluid to a single production borehole. Individual geo-fluid networks can be so sized, shaped, and located with respect to one another to form a collection of geo-fluid networks to mine heat from very large hot rock resources.

### CROSS REFERENCE TO RELATED APPLICATION(S)

This application claims priority benefit of provisional application Ser. No. 60/745,376 filed Apr. 21, 2006.

### BACKGROUND OF THE INVENTION

1. Field of the Invention

The present invention is related to geothermal power generation systems.

2. Description of the Related Art

The earth contains so much heat that it has been estimated that less than 0.1% of the earth's mass is cooler than 100° C. As one descends into the earth's crust the temperature rises by approximately 1 degree Fahrenheit for every 100 feet of depth. A 5000 foot gold mine shaft is about 50 degrees above the surface temperature. Some areas of the earth can be mined for heat by conventional geothermal energy production techniques. Some of these areas of the earth have naturally occurring hydrothermal reservoirs with high temperature water and/or steam at shallow depths and/or at lower depths in natural fractures of basement rock or in sedimentary rocks with relatively high permeability.

Access to and capacity of these naturally occurring hydrothermal reservoirs is rather limited so that other portions of the earth's mass containing relatively hot dry rock are also being developed for energy production by another conventional geothermal approach using Hot Dry Rock (a.k.a. Hot Rock Energy) technology. Here engineering enhancements are used to create an engineered geothermal reservoir from a volume of originally dry rock ranging from having relatively medium permeability (having some cracks or connected pore spaces) to being relatively impermeable (where there are little to no cracks or connected pore spaces).

Permeability of the volume of rock is increased to create the engineered geothermal reservoir through hydraulic stimulation by pumping water, pumping water with acids and/or with other chemicals, or pumping other sorts of fluids (such as carbon dioxide) all at high pressure through a borehole leading to pre-existing fracture systems of the rock volume. The pumping is generally done over a prolonged period of time such as weeks or months while progress is monitored.

The high pressure of the pumped fluid causes slippage between the natural fractures greatly increasing the gaps between the slipped portions of rock thereby greatly increasing permeability. When the high fluid pressure is reduced or stopped, the fractures partially close back up, however, the fractures do not match up with each other as they had before the pumped fluid was injected, so much of the gaps and the increased permeability remain. The slippage is tracked as it occurs through recording acoustic emissions. From these recordings, the engineered geothermal reservoir can be mapped.

In creating an engineered geothermal reservoir, some decisions are made regarding its size and location relative to the overall associated body of hot rock. Location of the engineered geothermal reservoir is dependent to a certain extent upon selection of the surface location of the borehole and the depth at which the fluid is injected from the borehole into the hot rock. The overall size of the engineered geothermal reservoir is a direct function of the total amount of fluid pumped into the hot rock during its development. Unfortunately, the overall configuration (including shape, orientation, and internal structure) of an engineered geothermal reservoir is almost entirely dependent upon geologic conditions local to the vicinity of the reservoir.

Once an engineered geothermal reservoir has been constructed, heat is mined by circulating a heat transfer fluid (also known herein as a “geo-fluid”) such as water or carbon dioxide into the reservoir through an injection borehole and extracting the heat containing geo-fluid from the reservoir through one or more production boreholes. The injection borehole is typically the borehole used for the original hydraulic stimulation.

Location of the one or more production boreholes coincide with the injection borehole and also need to account for shape, size, orientation, and internal structure of the engineered geothermal reservoir. Unfortunately, as the geo-fluid is circulated through the engineered geothermal reservoir, a portion of the geo-fluid is being continually lost due to such factors as retention of the fluid by the reservoir, gradual expansion of the reservoir, and leakage of the fluid out of the reservoir into rock volumes peripheral to the reservoir.

### BRIEF DESCRIPTION OF THE SEVERAL VIEWS OF THE DRAWING(S)

FIG. 1 is a side elevational schematic sectional view of a directional geothermal energy system.

FIG. 2 is a schematic view of a first implementation of a heat extraction system of the directional geothermal energy system of FIG. 1.

FIG. 3 is a schematic view of a second implementation of a heat extraction system of the directional geothermal energy system of FIG. 1.

FIG. 4 is a schematic view of a third implementation of a heat extraction system of the directional geothermal energy system of FIG. 1.

FIG. 5 is a schematic view of a fourth implementation of a heat extraction system of the directional geothermal energy system of FIG. 1.

FIG. 6 is a top plan schematic view of the first network version of the directional geothermal energy system of FIG. 1.

FIG. 7 is a bottom plan schematic view of the first network version of the directional geothermal energy system of FIG. 1.

FIG. 8 is a top plan schematic view of a collection of first network versions of the directional geothermal energy system of FIGS. 6 and 7.

### DETAILED DESCRIPTION OF THE INVENTION

As discussed herein, a directional geothermal energy system and method helps to increase control in paths to be taken by geo-fluid flow through hot rock to create an enhanced engineered geothermal reservoir. Increased control of geo-fluid flow paths can further allow for construction of planned geo-fluid flow path networks to mine heat from particular hot rock resources. Overall configuration, including shape and orientation, of the geo-fluid networks may be planned with less dependence upon local geological characteristics than found in conventional methods.

The system uses directional drilling techniques to create a spanning borehole (shown with portions being substantially horizontal) extending between an injection borehole and a production borehole. The spanning borehole typically extends through hot rock for a distance on the order of kilometers to allow the geo-fluid flowing through the spanning borehole adequate transit time and surface contact to obtain sufficient heat given a certain flow rate for the geo-fluid. As completed, the boreholes can be sealed from the surrounding rock and other geology by casings, liners, or other materials to prevent substantial loss of the geo-fluid from the system into the surrounding geology.

In some implementations, multiple injection boreholes can supply geo-fluid to a single production borehole to establish a geo-fluid network. Individual geo-fluid networks can be so sized, shaped, and located with respect to one another to form a collection of geo-fluid networks to mine heat from very large hot rock resources as further discussed below.

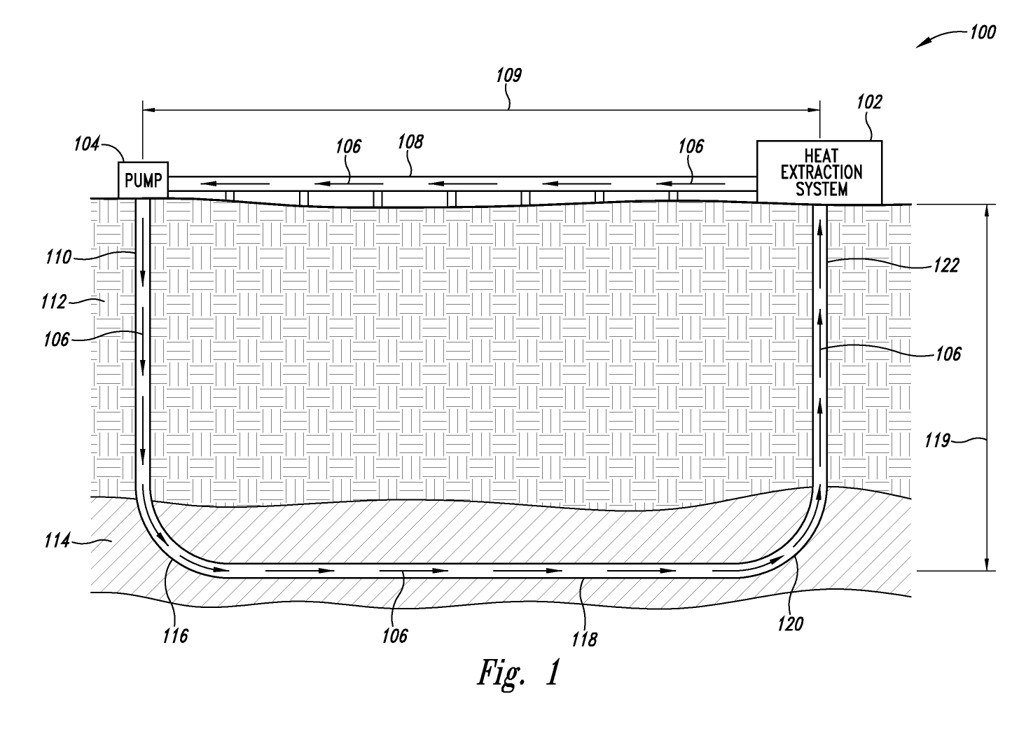

A directional geothermal energy system 100 is shown in FIG. 1 as having a heat extraction system 102 and an injection pump 104 (shown as substantially two locations along the earth's surface) to receive heat transfer fluid (geo-fluid) 106 from the heat extraction system via piping 108 extending a spacing 109 therebetween. The geo-fluid 106 can be water, liquid carbon dioxide, or other heat transfer fluids conventionally known or later discovered. The piping 108 is shown substantially horizontal, but in practice may be shaped to follow contours of the earth's surface between the heat extraction system 102 and the injection pump 104. The piping 108 is shown elevated above the earth's surface but in some implementations there may be reason for partially or fully burying portions or entire sections of the piping. In some implementations other pumps may be used in addition to or in replacement of the injection pump 104 such as being located in the heat extraction system 102.

The injection pump 104 pumps the geo-fluid 106 down an injection borehole 110 (shown as substantially vertical) through one or more upper strata 112 having temperatures below a desired hot rock temperature. The upper strata 112 could include rock formations and other geology that preferably have a high thermal resistance to impede heat loss from strata of hot rock located below the upper strata.

The injection borehole 110 extends through a portion of hot rock 114 to a spanning borehole portion including a first transition borehole portion 116 (shown as curved with a downward angle), which in turn extends through a portion of the hot rock 114 to further include a transverse borehole portion 118 (shown as substantially horizontal) at an approximate hot rock depth 119. A first drilling goal for the hot rock depth 119 could be to strata having a consistent approximate temperature of 80 degrees Centigrade (C) to utilize equipment capable of extracting power such as electrical power using the geothermal based energy. A second drilling goal for the hot rock depth 119 could be to reach consistent temperatures of approximately 140 degrees C. for more efficient extraction of geothermal based power. A third drilling goal for the hot rock depth 119 could be to reach temperatures of approximately 400-600 degrees C. to take advantage of a supercritical phase of one or more heat transfer fluids such as carbon dioxide to further increase energy conversion efficiencies. Investigation into use of supercritical phase heat transfer fluids with conventional systems is currently being undertaken, for example, by an ENEX project in Iceland.

The geo-fluid 106 travels along the transverse borehole portion 118 to absorb heat from the hot rock 114. The spanning borehole portion extends through the transverse borehole portion 118 to include a second transition borehole portion 120 (shown as curved with an upward angle), which in turn extends to a production borehole 122 (shown as substantially vertical) to the heat extraction system 102. The geo-fluid 106 travels up through the production borehole 122 back to the heat extraction system 102 to release absorbed heat. The spanning borehole portion, including the first transition borehole portion 116, the transverse borehole portion 118, and the second transition borehole portion 120, extends between the injection borehole 110 and the production borehole 122 to an extent substantially the spacing 109 of the piping 108 to provide a below ground return path for the geo-fluid 106 from the injection borehole to the production borehole complimentary to the path provided by the piping 108 substantially from the production borehole to the injection borehole.

A suggested approach to construct portions of the directional geothermal energy system 100 could utilize directional drilling techniques including the latest advances. The injection borehole 110 could be drilled at a first site to reach the hot rock 114. A first directional drilling drill head could be used to extend from the injection borehole 110 through the first transition borehole portion 116 into a first portion (such as approximately one half) of the transverse borehole portion 118.

The production borehole 122 could be drilled in a second site located substantially the spacing 109 in distance from the first site of the injection borehole 110. A second directional drilling drill head could be used to extend from the production borehole 122 through the second transition borehole portion 120 into a second portion (such as approximately one half) of the transverse borehole portion 118. The first drill head and the second drill head could meet at a mid-point along the transverse borehole portion 118 between the injection borehole 110 and the production borehole 122 to form a continuous underground return path from the pump 104 to the heat extraction system 102.

The injection borehole 110, the first transition borehole portion 116, the transverse borehole portion 118, the second transition borehole portion 120 and the production borehole 122 can be stabilized and sealed from the surrounding rock and other geology by casings, liners, or other materials and drilling techniques to prevent substantial loss of the geo-fluid from the system 100 into the surrounding geology. The particular values for the spacing 109 and the hot rock depth 119 will be determined for a particular implementation based upon geological conditions local to the drilling sites and drilling techniques used. For instance, in some implementations the spacing 109 could be approximately 5 kilometers in length. Other implementations could have ranges on the order of one to twenty kilometers as examples, but are not limited to such ranges.

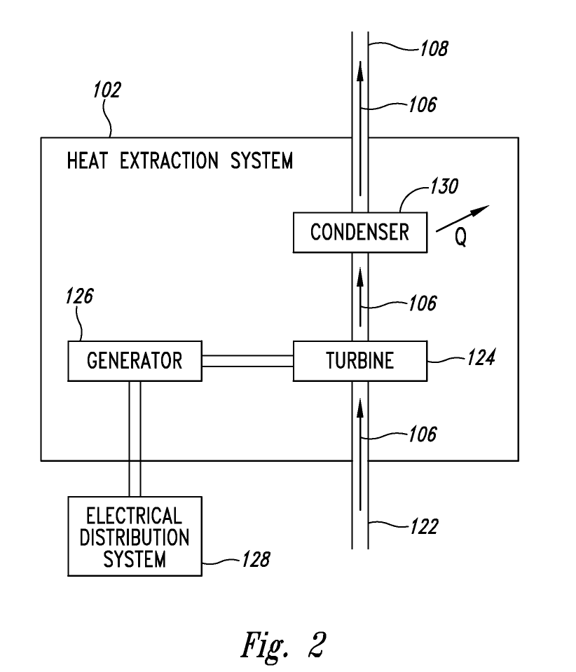

Heat mined by the directional geothermal system 100 has numerous uses some of which are exemplified herein in the following implementations of the heat extraction system 102. A first implementation of the heat extraction system 102 is shown in FIG. 2 as having a turbine 124 coupled to the production borehole 122 to receive the geo-fluid 106 containing heat absorbed from the hot rock 104. The turbine 124 converts some of the heat contained by the geo-fluid 106 into work to turn a generator 126 to input electrical power to an electrical distribution system 128. To improve thermodynamic efficiency of the turbine 124, a condenser 130 is also included to increase the temperature difference of the geo-fluid 106 entering and exiting the turbine 124.

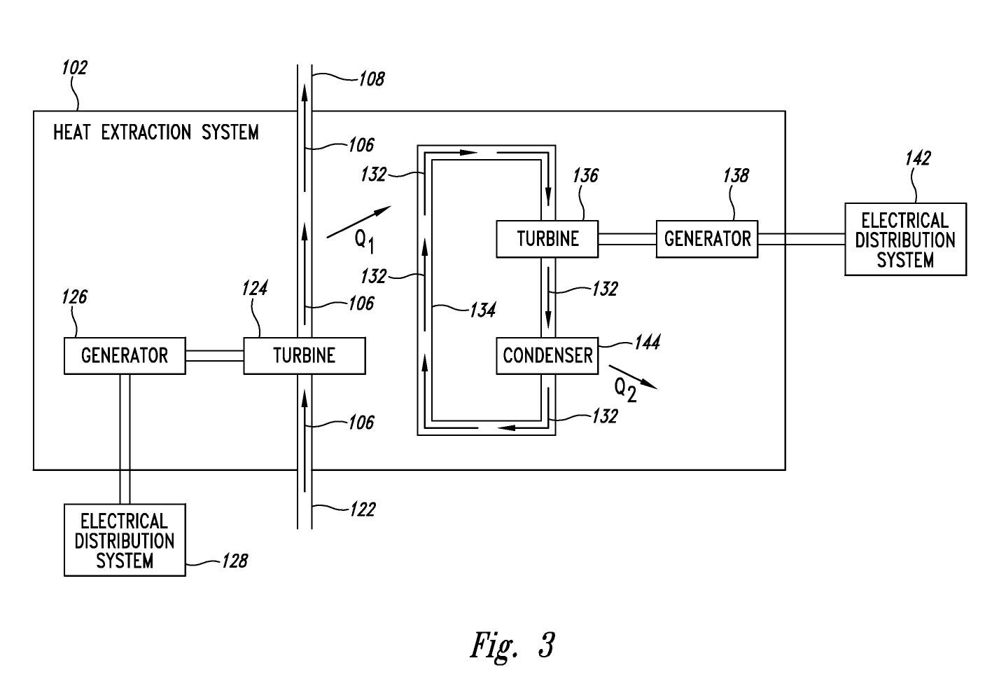

A second implementation of the heat extraction system 102 is shown in FIG. 3 as using a dual approach with the turbine 124 that directly receives the geo-fluid 106 of the first implementation and also a binary system in which a secondary heat-transfer fluid 132 such as an ammonia based or other based fluid receives heat from the geo-fluid 106 through exchanger-piping 134. A secondary turbine 136 converts some of the heat contained by the secondary heat-transfer fluid 132 into work to turn a generator 138 to provide electrical power to an electrical distribution system 142. A condenser 144 is also used to increase the temperature difference between the second heat-transfer fluid 132 entering and exiting the turbine 136 to improve energy conversion efficiencies.

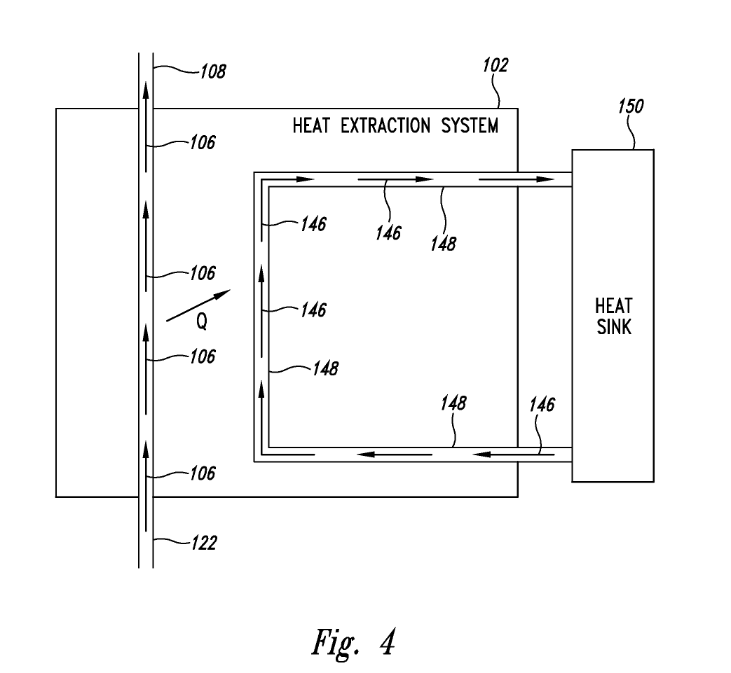

A third implementation of the heat extraction system 102 is shown in FIG. 4 as using a secondary heat transfer fluid 146 to receive heat from the geo-fluid 106 through an exchanger-piping system 148. The secondary heat transfer fluid 146 then sends heat to a heat sink 150. The heat sink 150 could be any sort of device or process that uses heat such as for drying or heating. For instance, such drying or heating could be used in agricultural applications, chemical manufacture applications, industrial applications, and/or architectural applications.

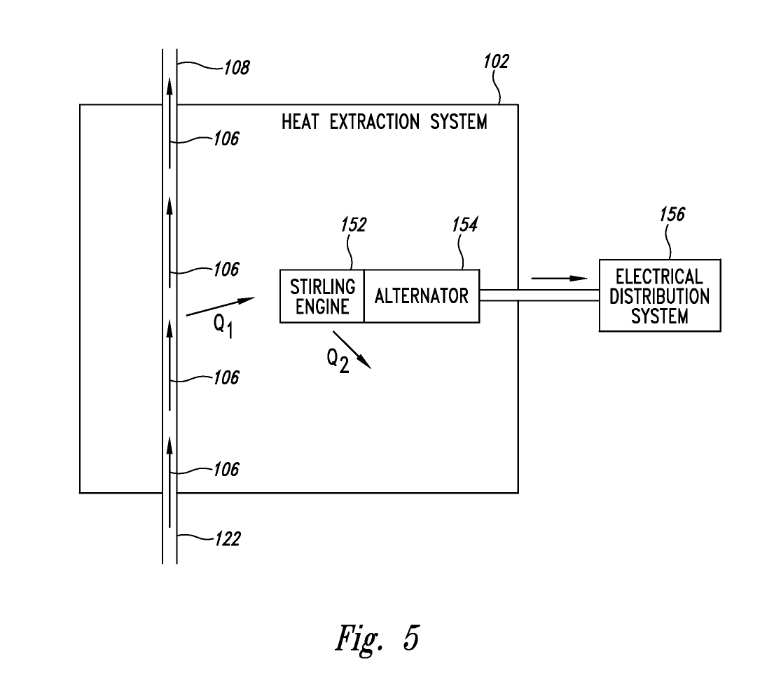

A fourth implementation of the heat extraction system 102 is shown in FIG. 5 as having a Stirling engine 152 to convert some of the heat from the geo-fluid 106 to work to move an alternator 154. The alternator 154 subsequently produces electric power that is sent to an electrical distribution system 156.

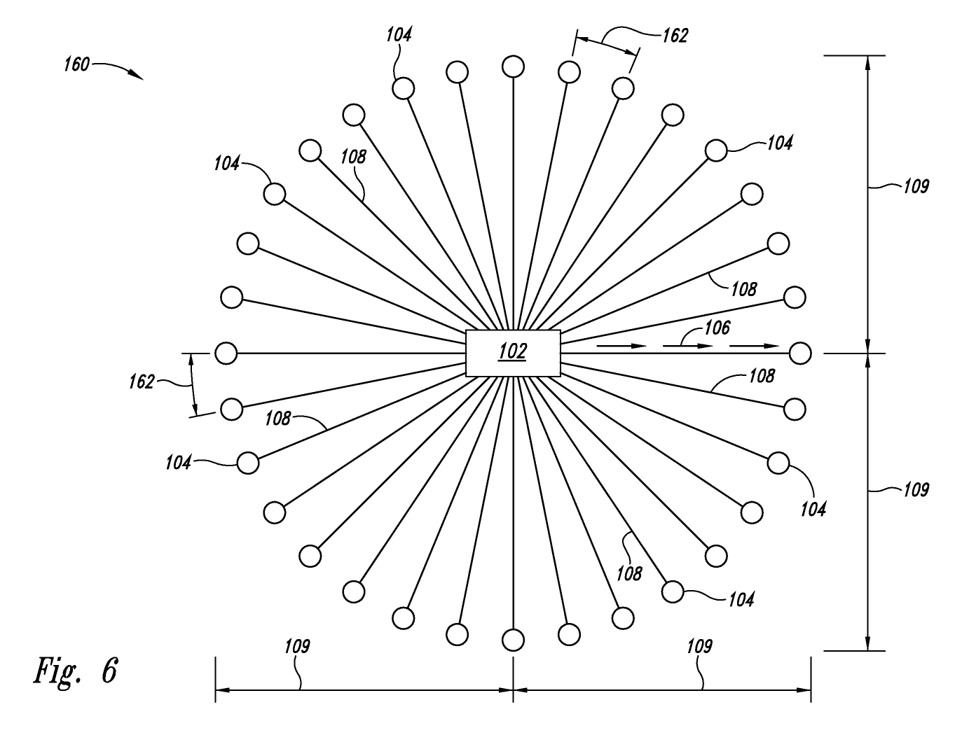

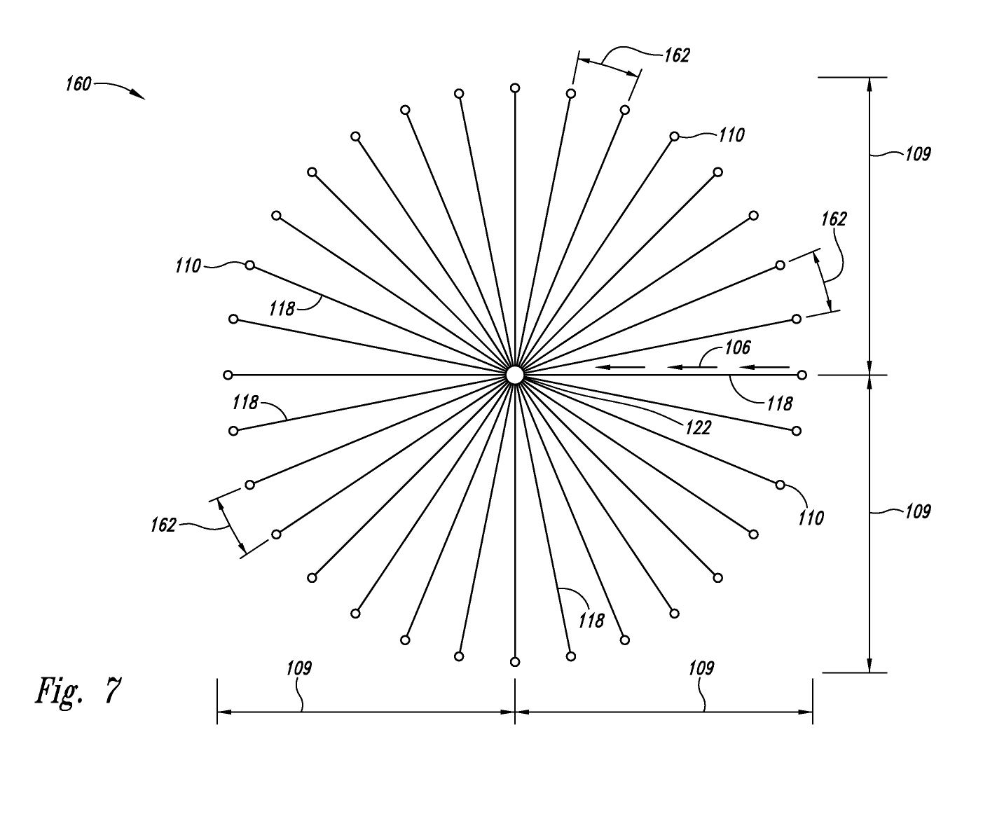

A geothermal network 160 of a plurality of the directional geothermal systems 100 has a plurality of the pumps 104 (shown in FIG. 6) and a plurality of the injection boreholes 110 (shown in FIG. 7) surrounding the heat extraction system 102. The injection boreholes 110 each have separate runs of the piping 108 to supply the geo-fluid 106. The injection boreholes 110 each use separate transverse borehole portions 118 to send their portions of the geo-fluid 106 back to the heat extraction system 102. In some implementations, the separate transverse borehole portions 118 are directly coupled to one (as shown in FIG. 7) or more instances of the production borehole 122 that are shared in common amongst the transverse borehole portions 118.

In other implementations, each spanning borehole portion is directly coupled with a different production borehole 122. Individual geo-fluid networks can be so sized, shaped, and located with respect to one another to form a collection of geo-fluid networks to mine heat from very large hot rock resources as further discussed below. Peripheral spacing 162 of the injection boreholes 110 between one another could be on the order of a kilometer. For instance, if the spacing 109 is on the order of 5 kilometers, the peripheral spacing 162 could be on the order of 1 to 2 kilometers.

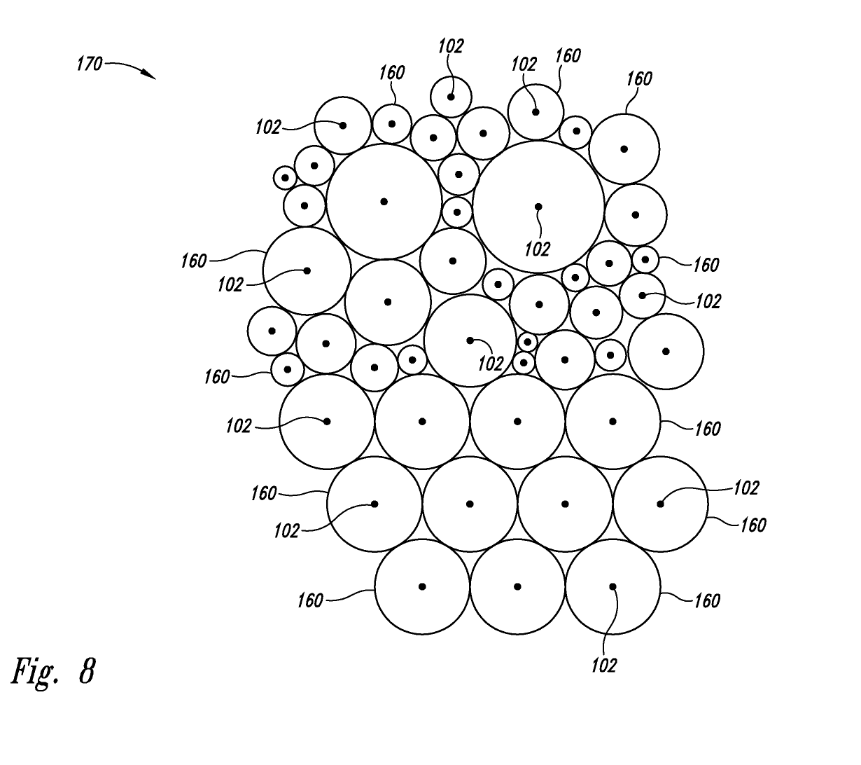

A collection 170 of a plurality of the geothermal networks 160 is shown in FIG. 8 as having individual sized and shaped geothermal networks 160. The geothermal networks 160 are arranged with one another to form the collection 170 of networks in order to extract heat from a large geothermal resource area. The rings around the heat extraction system 102 depicted as part of the geothermal network 160 indicate where the injection boreholes 110 could be located.

From the foregoing it will be appreciated that, although specific embodiments of the invention have been described herein for purposes of illustration, various modifications may be made without deviating from the spirit and scope of the invention. For instance implementations were shown as having injection boreholes and production boreholes as substantially vertical, however, in other implementations the injection boreholes and/or the production boreholes can include portions that are substantially non-vertical depending for instance upon local geology and constraints on location of drilling sites. Furthermore, the drilling depths of the injection boreholes and the production boreholes were shown as substantially the same, however, in other implementations, the drilling depths of the injection boreholes could be different than the drilling depths of the production boreholes.

Also, some of the injection boreholes 110 of a particular geothermal network 160 could be at different drilling depths from other injection boreholes of the geothermal network. Likewise, the transverse borehole portion 118 of the spanning borehole portion was depicted as being substantially horizontal, however, in other implementations the transverse borehole portion could be non-horizontal, for instance, to accommodate differing drilling depths between the injection borehole 110 and the production borehole 122. Accordingly, the invention is not limited except as by the appended claims.

The invention claimed is:

1. A system for hot rock located below an upper strata, the system comprising:
an injection borehole, at least a portion of the injection borehole extending through at least a first portion of the upper strata;
a production borehole extending through at least a second portion of the upper strata;
a heat extraction system coupled to the production borehole;
piping coupled to and extending between the heat extraction system and the injection borehole; and
a spanning borehole portion extending from the injection borehole to the production borehole, at least a first portion of the spanning borehole portion extending through a portion of the hot rock.

2. The system of claim 1 further including a heat transfer fluid positioned to circulate through a flow path including the injection borehole, the spanning borehole, the production borehole, and the piping, wherein the heat extraction system includes a turbine coupled to the production borehole to receive a heat transfer fluid from the production borehole.

3. The system of claim 1 further including a heat transfer fluid positioned to circulate through a flow path including the injection borehole, the spanning borehole, the production borehole, and the piping, wherein the heat extraction system includes a binary system with a second heat transfer fluid and a turbine coupled to receive the second heat transfer fluid, the binary system configured to transfer heat from the heat transfer fluid to the second heat transfer fluid.

4. The system of claim 1 wherein the heat extraction system includes a Stirling engine configured to receive heat from a heat transfer fluid flowing from the production borehole.

5. The system of claim 1 wherein the spanning borehole portion includes a first transition borehole portion, a transverse borehole portion, and a second transition borehole portion.

6. The system of claim 1 wherein the injection borehole, the spanning borehole portion, and the production borehole are substantially sealed to retain a heat transfer fluid therein.

7. The system of claim 1 wherein the spanning borehole portion extends through a portion of the hot rock for at least five kilometers.

8. The system of claim 1 wherein the spanning borehole portion extends through a portion of the hot rock for at least one kilometer.

9. The system of claim 1 wherein the first portion of the spanning borehole portion is configured to extend through a portion of the hot rock having a temperature of at least one of the following temperatures: 80 degrees centigrade, 140 degrees centigrade, and 400 degrees centigrade.

10. The system of claim 1 wherein a portion of the injection borehole is located substantially at a first location on the earth's surface and a portion of the production borehole is located substantially at a second location on the earth's surface and wherein the first location is at least one kilometer from the second location.

11. The system of claim 1 wherein a portion of the injection borehole is located substantially at a first location on the earth's surface and a portion of the production borehole is located substantially at a second location on the earth's surface and wherein the first location is at least five kilometers from the second location.

12. The system of claim 1 further including a heat transfer fluid, portions of the heat transfer fluid being substantially contained by a flow path for circulation therethrough to deliver heat from the hot rock to the heat extraction system, the flow path including the piping, the injection borehole, the spanning borehole portion, the production borehole, the piping, and the heat extraction system.

13. The system of claim 12 wherein the heat transfer fluid includes at least one of the following: water and carbon dioxide.

14. The system of claim 1 further including a heat transfer fluid positioned to circulate through a flow path including the injection borehole, the spanning borehole, the production borehole, and the piping, and further including a pump coupled to the injection borehole and coupled to the piping, the pump configured to impart motion to the heat transfer fluid.

15. A method of constructing a geothermal system comprising:
drilling an injection borehole, at least a portion of the injection borehole extending through at least a first portion of an upper strata;
drilling a production borehole, at least a portion of the production borehole extending through the upper strata;
using first directional drilling to drill a first portion of a spanning borehole from the injection borehole in a first direction toward the production borehole;
using second directional drilling to drill a second portion of the spanning borehole from the production borehole in a second direction toward the injection borehole, the first portion of the spanning borehole directionally drilled through a first geology at least a portion of which includes hot rock and the second portion of the spanning borehole directionally drilled through a second geology at least a portion of which includes hot rock to cause the first and second portions of the spanning borehole to meet therebetween;
coupling a heat extraction system to the production borehole; and
coupling a piping to the heat extraction system and to the injection borehole.

16. A system for hot rock located below an upper strata, the system comprising:
a plurality of injection boreholes, at least a portion of each of the injection boreholes extending through at least a first portion of the upper strata;
a production borehole extending through at least a second portion of the upper strata;
a heat extraction system coupled to the production borehole;
a plurality of piping coupled to and extending from the heat extraction system, each of the piping coupled to a different one the injection boreholes; and
a plurality of spanning borehole portions, each of the plurality of spanning borehole portions extending from a different one of the injection boreholes to the production borehole, at least a first portion of each of the spanning borehole portions extending through a different portion of the hot rock.
